(19) United States
(12) Patent Application Publication
(10) Pub. No.: US 2016/0001361 A1
(43) Pub. Date: Jan. 7, 2016

(54) SILVER POWDER AND SILVER PASTE

(71) Applicant: SUMITOMO METAL MINING CO., LTD., Tokyo (JP)

(72) Inventors: Toshiaki TERAO, Ehime (JP); Yuji KAWAKAMI, Ehime (JP); Akihiro MURAKAMI, Ehime (JP)

(73) Assignee: SUMITOMO METAL MINING CO., LTD., Tokyo (JP)

(21) Appl. No.: 14/647,722

(22) PCT Filed: Jul. 11, 2013
(86) PCT No.: PCT/JP2013/068971

§ 371 Date: May 27, 2015

(30) Foreign Application Priority Data
Nov. 29, 2012 (JP) 2012-260709

(51) Int. Cl. B22F 1/00; H01B 1/02; C09D 5/24; C22C 5/06

(52) U.S. Cl. CPC B22F 1/0003; C22C 5/06; H01B 1/02; C09D 5/24

(57) ABSTRACT

A silver powder is provided that has thixotropy suitable for utilization as a paste, combines the thixotropy with good dispersibility, is easy to knead, and prevents flake generation. The silver powder has a maximum torque per specific surface area of not less than 2 N·g/m and not more than 5 N·g/m, the maximum torque per specific surface area being obtained by dividing a maximum torque determined in accordance with a method for measuring an absorption amount defined by JIS K6217-4 by a specific surface area determined by the BET method.

### FIELD OF THE INVENTION

The present invention relates to a silver powder and a silver paste containing the silver powder, and more specifically, relates to a silver powder serving as a main component of a silver paste which is to be used for forming a wiring layer, an electrode, and the like of an electronic apparatus, and the silver paste. The present application claims priority based on Japanese Patent Application No. 2012-260709 filed in Japan on Nov. 29, 2012. The total contents of the patent application are to be incorporated by reference into the present application.

### BACKGROUND ART

Silver pastes, such as a resin type silver paste and a baked type silver paste, have been widely used for forming a wiring layer, an electrode, and the like of an electronic apparatus. In other words, these silver pastes are applied to or printed on various kinds of substrates, and then heat-cured or heat-baked, whereby an electrically conductive film to serve as a wiring layer, an electrode, or the like is formed.

For example, the resin type silver paste comprises a silver powder, a resin, a curing agent, a solvent, and the like, and the resin type silver paste is printed on a conductor circuit pattern or on a terminal, and heat-cured at a temperature of 100 to 200° C. to be made into an electrically conductive film, whereby wiring or an electrode is formed. On the other hand, the baked type silver paste comprises a silver powder, glass, a solvent, and the like, and the baked type silver paste is printed on a conductor circuit pattern or on a terminal, and heat-baked at a temperature of 600 to 800° C. to be made into an electrically conductive film, whereby wiring or an electrode is formed. In the wiring and the electrodes each formed of these silver pastes, an electric current path in which an electrical connection is established by linkages between the silver powder is formed.

The silver powder to be used for the silver paste has a particle diameter of 0.1 μm to a few μm, and the particle diameter of the silver powder to be used differs depending on the thickness of a wiring or an electrode to be formed, and the like. Furthermore, uniform dispersion of the silver powder in the paste enables the formation of wiring having a uniform thickness or an electrode having a uniform thickness.

To produce the silver paste, first, the silver powder is well mixed with another component, such as a solvent, and then kneaded by a rotary and revolutionary kneading machine, a three-roll mill, or the like.

In the case where the silver powder is insufficiently dispersed in the paste, the silver powder sediments in the paste, whereby the paste is made non-uniform. When a wiring layer or an electrode is formed using such non-uniform silver paste, the silver powder is non-uniformly present in the wiring layer or the electrode, and, as a result, a portion having no silver powder present therein is locally formed, and therefore, sufficient electrical conductivity is not achieved.

On the other hand, a paste having excellent dispersibility of the silver powder has a good storage property, but has high thixotropy, and therefore, bleeding and poor plate-releasability are caused at the time of screen printing, whereby insufficient wiring is formed. Thixotropy indicates how easy a high viscous fluid rapidly changes into a low viscosity fluid by a stress from outside, and is related to the interaction between particles and the dispersibility thereof. As dispersed-particles are monodispersed and the interaction between particles is stronger, the thixotropy is higher.

Thus, the dispersion of a silver powder in a paste has a great effect on printability in screen printing and on electrical conductivity. Therefore, it is important that a silver powder is moderately dispersed in a solvent, and it is desired that the silver powder has both not too high thixotropy and dispersibility.

Patent Literature 1 proposes a method for producing a silver powder, wherein a silver nitrate solution is added to a reducing agent solution containing sulfite and hydroquinone at a reaction temperature of not more than 100° C., and subsequently, ammonia is added to the reaction solution containing crystalline nuclei, whereby there is obtained a silver powder that has an average particle diameter in a range of 0.3 to 6.0 μm, is monodispersed, and has a narrow particle size distribution.

However, although, in this proposal of Patent Literature 1, it is disclosed that a silver powder which is monodispersed and has a narrow particle size distribution is obtained, there is no description about the particle size distribution of the obtained silver powder. Furthermore, in Patent Literature 1, there is no consideration for thixotropy, which matters when a paste is used for screen printing, and hence, it is hard to say that the sufficient dispersibility of silver in the paste is ensured.

Here, the interaction between particles which is related to thixotropy can be calculated by a relational expression of a shearing stress to a normal stress of silver particles. The relationship between the normal stress and the shearing stress is shown in Formula 1.

Shearing Stress (N/cm²)=a+b×Normal Stress (N/cm²) Formula 1

Here, “a” in Formula 1 represents a shearing stress in the case where there is no normal stress. This is called an aggregation force between particles. In Formula 1, “b” represents an internal friction angle. The determination of “a” enables the calculation of the aggregation force between particles, that is, the interaction therebetween. In the paste, the interaction between silver particles via a liquid is reflected, and hence, a value of “a” in Formula 1 is qualitative, but, it is hard that the value of “a” is in perfect agreement with the paste in behavior.

### PRIOR-ART DOCUMENTS

### Patent Document

Patent document 1: Japanese Patent Application Laid-Open No. 2005-048236

### SUMMARY OF THE INVENTION

### Problems to be Solved by the Invention

In view of such conventional actual circumstances, an object of the present invention is to provide a silver powder having thixotropy suitable for utilization as a paste and combining the thixotropy with dispersibility.

### Means to Solve the Problem

To achieve the foregoing object, the present inventors earnestly made a study and consequently found that the particle diameter of a silver powder and pulverization of the silver powder are controlled so as to achieve an optimum torque per unit surface area of the silver powder which is calculated by dividing a maximum torque by a specific surface area of the silver powder, the maximum torque being obtained when a certain amount of the silver powder is agitated and an organic solvent is dropped thereinto, whereby the silver powder had both good dispersibility in a paste and not too high thixotropy, thereby improving bleeding and poor plate-releasability in screen printing, and thus the inventors accomplished the present invention.

In other words, a silver powder according to the present invention has a maximum torque per specific surface area of not less than 2 N·g/m and not more than 5 N·g/m, the maximum torque being obtained in such a manner that a maximum torque which is determined by a measurement method of absorption amount specified in Japanese Industrial Standard (JIS) K6217-4 is divided by a specific surface area determined using the BET method.

Here, the silver powder according to the present invention preferably has a number average particle diameter D_{SEM} of not less than 0.2 μm and not more than 2.0 μm, the D_{SEM} being determined by an image observed by a scanning electron microscope, and preferably has a ratio D₅₀/D_{SEM} of not less than 1.8 and not more than 4.2, the ratio D₅₀/D_{SEM} being a ratio of a particle diameter D₅₀ on a volume basis measured by laser diffraction scattering to the number average particle diameter D_{SEM}.

Furthermore, the silver powder according to the present invention preferably has a volume resistivity of not more than 10 μΩ·cm when a silver paste obtained by kneading the silver powder, terpineol, and a resin using a rotary and revolutionary agitator at a centrifugal force of 420 G is printed on an alumina substrate and baked for 60 minutes at a temperature of 200° C. in the atmosphere.

### Effects of Invention

The silver powder according to the present invention has good dispersibility in a silver paste, and has optimum thixotropy for printing the silver paste with the dispersibility being maintained. Furthermore, a silver paste according to the present invention contains the silver powder having both dispersibility and optimum thixotropy, and therefore has good printability and enables an electrically conductive film excellent in electrical conductivity to be formed.

### BRIEF DESCRIPTION OF DRAWINGS

FIG. 1 schematically illustrates the form of silver particles according to the present invention.

### DETAILED DESCRIPTION OF THE INVENTION

Hereinafter, a specific embodiment of a silver powder and a silver paste according to the present invention will be explained in detail. It should be noted that the present invention is not limited only to the following embodiment, and various changes may be suitably made within the scope not deviating from the gist of the present invention.

<Silver Powder and Silver Paste>

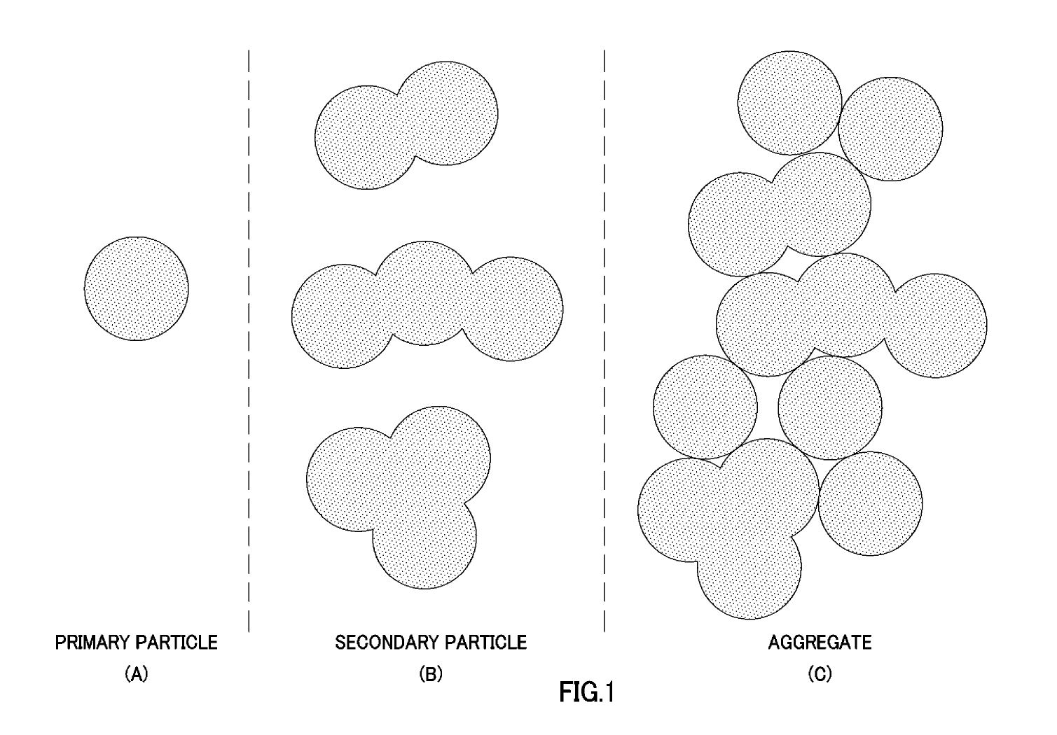

The silver powder includes not only silver particles as primary particles, but also secondary particles and aggregates. In the following description, as illustrated in FIG. 1 (A), the primary particles represent silver particles regarded as a unit particle when judged from a geometric form of the silver particles in terms of appearance, and, as illustrated in FIG. 1 (B), the secondary particles represent particles which are such that not less than two to three primary particles are connected to each other by necking. As illustrated in FIG. 1 (C), the aggregates represent aggregates of the primary particles and the secondary particles. It should be noted that, in the following description, the primary particles, the secondary particles, and the aggregates are sometimes collectively called silver particles.

The silver powder has a coating layer containing a surface treatment agent on the surfaces of the particles. The coating layer is formed of a surface active agent and/or a dispersing agent. Thus, the silver powder can prevent excessive aggregation of the silver particles, and allows desired aggregates to be maintained.

The silver powder has a particle diameter D₅₀ of not less than 0.5 μm and not more than 2.0 μm, the particle diameter D₅₀ being obtained at the point of 50% of a cumulative curve that is determined with the total volume of all the silver particle groups being taken as 100%, the total volume being measured by laser diffraction scattering.

Furthermore, the silver powder has a number average particle diameter D_{SEM} of not less than 0.2 μm and not more than 2.0 μm, the D_{SEM} being determined by an image observed by a scanning electron microscope.

Furthermore, the silver powder has a ratio D₅₀/D_{SEM} of preferably not less than 1.8 and not more than 4.2, more preferably not less than 1.8 and not more than 3.5, the ratio D₅₀/D_{SEM} being a ratio of a particle diameter D₅₀ on a volume basis measured by laser diffraction scattering to a number average particle diameter D_{SEM} determined by an image observed by a scanning electron microscope. In the case where the ratio D₅₀/D_{SEM} is more than 4.2, coarse aggregates are relatively more present in the silver powder, and the dispersibility of the silver powder in a paste is sometimes reduced. On the other hand, a ratio D₅₀/D_{SEM} of less than 1.8 indicates a state in which the silver particles hardly form aggregates, whereby better dispersibility is achieved, but thixotropy is made too high, thereby causing printing defects. Therefore, a ratio D₅₀/D_{SEM} of not less than 1.8 and not more than 4.2 allows too many coarse aggregates not to be produced and good dispersibility to be achieved, and also allows too high thixotropy not to be caused and the occurrence of printing defects and poor plate-releasability to be prevented.

Thus, a silver powder having a ratio D₅₀/D_{SEM} of not less than 1.8 and not more than 4.2 has not coarse aggregates but aggregates of the proper size for achieving dispersibility, and the silver powder is silver particles having a structure that prevents the dispersibility of each the primary particle from being higher than a fixed level.

In the case of a silver powder having a particle size distribution in which aggregates formed by sparsely-aggregating silver particles are included, the aggregates have a large mass, whereby the silver powder easily sediments in a paste, and therefore, the dispersion state of the silver powder in the paste is not stable, whereby a electrically conductive film obtained has poor electrical conductivity.

On the other hand, in the case of a silver powder including no aggregate, the dispersion state of the silver powder in a paste is stable, but, the silver powder has high thixotropy, whereby problems, such as bleeding and poor plate-releasability, are caused when wiring and the like are printed.

On the other hand, a silver powder in the present embodiment maintains a certain dispersibility and includes aggregates having a proper size, and therefore, for example, in the case where the silver particles are used for a paste to be baked, the silver particles are easily sintered, and an electrically conductive film paste which is excellent in uniformity and electrical conductivity can be obtained.

Here, the thixotropy indicates how easy a high viscous fluid rapidly changes into a low viscosity fluid by a stress from outside, and is related to the interaction between particles and the dispersibility thereof. In other words, as dispersed particles are monodispersed and the interaction between the particles is stronger, the thixotropy is higher. Whether dispersed particles are monodispersed or not can be judged by measuring a particle size distribution using a measurement method, such as laser diffraction type particle-size-distribution measurement.

The interaction between particles includes not only the interaction between the surfaces of the particles, but also the size of the contact points between the surfaces of the particles in a dispersed state. Even if the interaction between the surfaces of the particles is stronger, the presence of many aggregates and a low contact ratio between the surfaces of the aggregates in a paste cause the interaction as the whole of the paste to be smaller and the thixotropy to be lower.

Too low thixotropy causes insufficient flowability at the time when a shearing force is applied, and, for example, in screen printing, a paste is not sufficiently distributed into a mesh at the time of printing, whereby a printing blur and line breaking are caused.

Thus, in the silver powder, the interaction between particles is important. The dispersion of the silver powder in a paste has a great effect on printability at the time of screen printing and on electrical conductivity. Therefore, it is important for the silver powder to have a moderate dispersibility in a solvent, and, it is desirable that, in the silver powder, there are both moderate thixotropy and the dispersion of the silver powder in the paste.

Here, to measure the size and the number of aggregates, the amount of a dibutyl phthalate ester absorbed serves as an index. Specifically, the measurement is conducted according to Japanese Industrial Standard (JIS) K6217-4 (2008).

According to JIS K6217-4, a dibutyl phthalate ester is dropped, and a dropping amount at the time when a torque reaches 70% of the maximum torque is regarded as the amount of the dibutyl phthalate ester absorbed. It is known that the absorbed amount is proportional to the size and the number of aggregates.

The torque mentioned here is a torque applied to a jig which agitates the silver powder. When a dibutyl phthalate ester starts to be dropped, the dibutyl phthalate ester is incorporated into the inside of the aggregates, and at the time when the dibutyl phthalate ester is gradually filled in the inside and then no longer incorporated thereinto, the dibutyl phthalate ester forms a film on the surfaces of the aggregates. In the case of particles having no aggregate, the dibutyl phthalate ester forms a film on the surfaces of the particles without being incorporated into the particles. The contact between the particles is performed via this liquid film, and the Laplace pressure occurs there, thereby causing an adsorption action between the particles, and the action appears as the torque of a jig, accordingly. When the surfaces of the particles are coated with the liquid film and furthermore an excessive dibutyl phthalate ester is supplied, the liquid enters between the films, the Laplace pressure rapidly decreases, and the torque applied to the jig is reduced. In other words, when a dibutyl phthalate ester is dropped, a dropping amount which indicates the maximum torque appears. This maximum torque indicates a total of the interactions between the aggregates and the dispersed particles, and hence it can be said that a higher value of the torque indicates a silver powder in which there is a higher interaction between the particles. This interaction causes the high viscosity of a paste at the time when a shearing force is not applied, and, when a shearing force that exceeds this torque is applied like in the printing, a particle structure that is formed by the interaction collapses and the paste changes into a low viscous fluid. Therefore, a low affinity of the particles for a solvent leads to a stronger interaction between the particles and higher thixotropy. That is, the thixotropy is affected by not only the foregoing aggregates, but also the affinity of the particles for a solvent. The silver powder according to the present embodiment has a coating layer containing a surface treatment agent on the surfaces of the particles, and therefore has a high affinity for a solvent and allows both dispersibility and thixotropy to be kept.

Actually, a smaller particle diameter, a larger specific surface area, and a higher affinity of the particles for a solvent lead to a higher apparent torque. Hence, in the case of focusing on the characteristics of a powder surface, the maximum torque per unit specific surface area can more reflect the characteristics of the powder surface. In other words, the use of a value obtained by dividing the maximum torque by a specific surface area enables the ascertainment of the characteristics of powders each having different particle diameters.

For the silver powder in the present embodiment, according to JIS K6217-4 (2008), a maximum torque A which is obtained when a dibutyl phthalate ester is dropped into 200 g of the silver powder is determined using an absorption meter S-500 manufactured by Asahisouken Co., Ltd., and, separately, a specific surface area B is determined based on the BET theory, and then, when a maximum torque per unit specific surface area C is calculated by applying the following Formula 2, a value of not less than 2 N·g/m and not more than 5 N·g/m is given.

C (N·g/m)=A (Nm)/B (m²/g) Formula 2

When the maximum torque of the silver powder is not less than 2 N·g/m and not more than 5 N·g/m, the silver powder has not too high thixotropy while maintaining moderate dispersibility. When the maximum torque is less than 2 N·g/m, the silver powder has low dispersibility and has low liberation and low thixotropy in a paste, whereby the lack of flowability is caused when a shearing force is applied at the time of printing. On the other hand, when the maximum torque exceeds 5 N·g/m, the silver powder has high thixotropy, and a paste has too low a viscosity at the time of printing, whereby bleeding and poor plate-releasability are caused.

A silver paste using such silver powder contains not less than 50% by mass of the silver powder. The use of the foregoing silver powder allows the silver paste to have good electrical conductivity. Specifically, when the silver paste is printed on an alumina substrate and baked for 60 minutes at 200° C. in the atmosphere, the volume resistivity is not more than 10 μΩ·cm.

Volume resistivity has an effect on electrical energy loss. A volume resistivity of more than 10 μΩ·cm causes a larger electrical energy loss of a wiring layer and an electrode each formed using the silver paste, thereby leading to a reduction in electrical conductivity. Therefore, the volume resistivity that yields good conductivity is not more than 10 μΩ·cm, preferably not more than 9 μΩ·cm.

The foregoing silver powder comprises fine silver particles formed of dispersed primary particles having the foregoing particle size distribution, and accordingly, hardly sediments in a paste, has excellent dispersibility, and is not unevenly distributed in the paste, and therefore, allows the volume resistivity to be not more than 10 μΩ·cm and exhibits excellent electrical conductivity.

It should be noted that the silver paste to be used in the evaluation of the particle size distribution of the silver powder in the silver paste and the evaluation of the volume resistivity at the time of printing and baking the silver paste is not particularly limited, and, for example, there may be employed a silver paste which is obtained in such a manner that 8.0% by mass of a vehicle and 92.0% by mass of a silver powder with respect to the whole amount of the paste are kneaded at 420 G for 5 minutes by using a rotary and revolutionary kneading machine, the vehicle having a mass ratio of an epoxy resin (having a viscosity of 2 to 6 Pa·s, for example, JER819, manufactured by Mitsubishi Chemical Corporation) to terpineol of 1:7.

It is a matter of course that the silver powder is not limited to the application to the foregoing silver paste, but is applicable to all silver pastes which have been commonly used.

Furthermore, in the production of a silver paste by using a silver powder having the foregoing characteristics, a method for turning the silver powder into a paste is also not particularly limited, and a well-known method may be employed. A vehicle to be used is not particularly limited, and, for example, there may be used a vehicle obtained by dissolving various kinds of cellulose, phenol resin, acrylic resin, or the like in a solvent, such as an alcoholic solvent, an ether-based solvent, or an ester-based solvent.

The silver powder in the present embodiment has not only an excellent dispersibility in a paste, but also moderate thixotropy that is necessary for a good printing property. Therefore, the silver powder does not need to undergo redispersion treatment for use, whereby screen printing and the like can be efficiently conducted with high productivity. Furthermore, a wiring layer and an electrode each formed using a resin type or a baked type silver paste containing the foregoing silver powder are excellent in electrical conductivity, and therefore the silver powder can be suitably used for a silver paste that is employed for forming a wiring layer, an electrode and the like of an electronic apparatus.

<Method for Producing the Silver Powder>

The silver powder can be produced using silver chloride or silver nitrate as a raw material. Taking a case where silver chloride is used as a starting material as a preferable aspect, every step of a method for producing the silver powder will be more specifically described. It should be noted that, also in the case where a material other than silver chloride is used as a starting material, the silver powder can be obtained in the same way as in the case of using silver chloride, but, in the case where silver nitrate is used as a starting material, it is necessary to install equipment for collecting nitrous acid gas and equipment for treating nitrate-based nitrogen contained in waste water.

In the method for producing the silver powder, first, a reduction step of forming a silver particle slurry by a wet reduction method is performed, the wet reduction method being such that a silver complex solution containing a silver complex obtained by dissolving silver chloride with a complexing agent is mixed with a reducing agent solution, whereby the silver complex is reduced to precipitate silver particles.

In the reduction step, first, silver chloride as a starting material is dissolved using a complexing agent, whereby a solution containing a silver complex is prepared. The complexing agent is not particularly limited, but, there is preferably used aqueous ammonia, which easily forms a complex with silver chloride and does not contain a component that is to remain as an impurity. Furthermore, as the silver chloride, high-purity silver chloride is preferably used.

A method for dissolving silver chloride is such that, for example, in the case where aqueous ammonia is used as a complexing agent, aqueous ammonia may be added to a slurry of silver chloride or the like produced, but, in order to increase the concentration of a complex and to raise productivity, silver chloride is preferably added into aqueous ammonia and dissolved therein. As the aqueous ammonia to be used for the dissolution, ordinary aqueous ammonia for industrial use may be used, but, aqueous ammonia having a purity as high as possible is preferably used in order to prevent impurity contamination.

Next, a reducing agent solution to be mixed with a silver complex solution is prepared. As a reducing agent, a material having strong reducing power, such as ascorbic acid, hydrazine, or formalin, is preferably used. Particularly, ascorbic acid is preferably used because crystalline particles in silver particles easily grow. Hydrazine and formalin have stronger reducing power than ascorbic acid, and therefore allows crystals in silver particles to be made smaller. Furthermore, in order to control reaction uniformity or reaction rate, there may be used an aqueous solution whose concentration is adjusted by dissolving or diluting a reducing agent with pure water or the like.

In order to prevent excessive aggregation of silver particles and to control formation of secondary particles and aggregates, a water soluble polymer is added to a reducing agent solution. The amount of a water soluble polymer added is 2.5% to 13.0% by mass, preferably 2.5% to 10.0% by mass, more preferably more than 3.0% by mass and not more than 10.0% by mass, with respect to silver.

The choice of a water soluble polymer as an aggregation inhibitor and the amount of the water soluble polymer added are of importance to the production of the silver powder according to the present embodiment. The silver particles (primary particles) formed by the reduction using a reducing agent solution have active surfaces, thereby easily coupling to other silver particles and forming secondary particles. Furthermore, the secondary particles aggregate to form aggregates. At this time, the use of an aggregation inhibitor having a high effect of preventing aggregation, such as a surface active agent or fatty acid, causes insufficient formation of the secondary particles and the aggregates, whereby the primary particles increase and aggregates of a moderate size are not formed.

On the other hand, the use of an aggregation inhibitor having a low effect of preventing aggregation causes excessive formation of the secondary particles and the aggregates, whereby a silver powder containing excessively aggregating and coarse aggregates is formed. Water soluble polymers have a moderate effect of preventing aggregation, and therefore, the adjustment of the amount of a water soluble polymer added allows formation of the secondary particles and the aggregates to be easily controlled, whereby the aggregates of a moderate size can be formed in a silver complex containing solution obtained after a reducing agent solution is added.

The water soluble polymer to be added is not particularly limited, but preferably at least one kind selected from polyethylene glycol, polyvinyl alcohol, polyvinyl pyrrolidone, gelatin, and the like, more preferably at least one kind selected from polyethylene glycol, polyvinyl alcohol, and polyvinyl pyrrolidone. These water soluble polymers prevent particularly excessive aggregation and also prevent silver particles (primary particles) from being made minute due to insufficient aggregation of grown-up nuclei, whereby a silver powder including aggregates of a predetermined size can be easily formed.

Here, a mechanism in which, by the addition of a water soluble polymer, silver particles are made to be connected to each other to form aggregates of a predetermined size is considered as follows. That is, when a water soluble polymer is added, the water soluble polymer adsorbs onto the surfaces of the silver particles. At this time, when almost all of the silver particle surfaces are coated with a water soluble polymer, each of the silver particles is present independently, but, it is considered that the addition of the water soluble polymer at a predetermined ratio with respect to silver allows a part of the surfaces to remain without the presence of the water soluble polymer, whereby the silver particles are connected to each other via the surfaces to form aggregates.

Hence, the amount of a water soluble polymer added is 2.5% to 13.0% by mass, preferably 2.5% to 10.0% by mass with respect to silver. In the case where the amount of a water soluble polymer added is less than 2.5% by mass with respect to silver, dispersibility in a silver particle slurry is worsened, whereby a silver powder excessively aggregates and many coarse aggregates are generated.

On the other hand, in the case where the amount of a water soluble polymer added is more than 13.0% by mass with respect to silver, almost all of the silver particle surfaces are coated with the water soluble polymer, whereby silver particles cannot be connected to each other and accordingly aggregates cannot be formed. As a result, the silver powder comprises primary particles, and, in this case, flakes are generated at the time of paste production.

Therefore, the addition of 2.5% to 13.0% by mass of a water soluble polymer with respect to silver enables silver particles to be moderately connected to each other via the surfaces on which the water soluble polymer is not present, and structurally stable aggregates to be formed, whereby good dispersibility at the time of paste production can be achieved, and also flake generation can be effectively prevented. Furthermore, it is more preferable to add a water soluble polymer at 2.5% to 10.0% by mass with respect to silver. The addition amount of 2.5% to 10.0% by mass of a water soluble polymer enables the water soluble polymer to adsorb more moderately onto the silver particle surfaces; silver particles to be connected to each other to the extent that the connected silver particles have a predetermined size to form highly stable aggregates; and flake generation to be more effectively prevented.

A water soluble polymer is preferably added to a reducing agent solution. Such addition leads to the water soluble polymer to be present at the stage of nucleation or nucleus growth, and the water soluble polymer to quickly adsorb onto the surfaces of formed nuclei or silver particles, whereby aggregation of the silver particles can be efficiently controlled. Thus, the advance addition of a water soluble polymer to a reducing agent solution in combination with the foregoing adjustment of concentration of the water soluble polymer allows the formation of coarse aggregates due to excessive aggregation of silver particles to be prevented, and silver particles to be more moderately connected to each other to the extent that the connected silver particles have a predetermined size, thereby forming highly stable aggregates.

It should be noted that a part or the whole of the amount of a water soluble polymer to be added may be added beforehand to a silver complex containing solution, but, in this case, the water soluble polymer is hardly supplied at the stage of nucleation or nucleus growth, and accordingly there is a risk that the water soluble polymer cannot adsorb moderately onto the surfaces of silver particles. Therefore, in the case where a water soluble polymer is added beforehand to a silver complex containing solution, the amount of the water soluble polymer added is preferably more than 3.0% by mass with respect to silver. Hence, in the case of making it possible to add a water soluble polymer to any solution of a reducing agent solution and a silver complex containing solution, the amount of the water soluble polymer added is particularly preferably more than 3.0% by mass and not more than 10.0% by mass with respect to silver.

Furthermore, the addition of a water soluble polymer sometimes causes foaming at the time of a reduction reaction, and therefore a defoaming agent is preferably added to a silver complex containing solution or a reducing agent mixed solution. The defoaming agent is not particularly limited, and a defoaming agent which has been commonly used at the time of reduction may be employed. It should be noted that, in order not to inhibit a reduction reaction, the amount of a defoaming agent added is preferably a minimum amount required to achieve defoaming effects.

As for water to be used for preparation of a silver complex containing solution and a reducing agent solution, in order to prevent contamination with impurities, water from which impurities are removed is preferably used, and pure water is particularly preferably used.

Next, the silver complex containing solution and the reducing agent solution which are prepared as mentioned above are mixed to reduce a silver complex, whereby silver particles are precipitated. For this reduction reaction, a batch method may be employed, or a continuous reduction method, such as a tube reactor method or an overflow method, may be employed. In order to obtain primary particles having a uniform particle diameter, a tube reactor method is preferably used since the method allows particle growth time to be easily controlled. Furthermore, it is possible to control the particle diameter of the silver particles by a mixing rate of a silver complex containing solution and a reducing agent solution or a reduction rate of a silver complex, whereby the particle diameter of silver particles can be easily controlled to a target particle diameter.

Next, a surface treatment is applied to the silver particles to form a coating layer on the surfaces of the silver particles. This surface treatment step is such that, prior to the formation of coarse aggregate masses by further aggregation of aggregates formed by reduction in the silver complex containing solution, a surface treatment is applied to the surfaces of the formed aggregates with a treatment agent having a high effect of preventing aggregation to prevent excessive aggregation. In other words, after the foregoing aggregates are formed and before excessive aggregation proceeds, the silver particles are treated with a surface active agent, or more preferably, the silver particles are treated with a surface active agent and a dispersing agent. Such treatment enables excessive aggregation to be prevented, the structural stability of desired aggregates to be maintained, and the formation of coarse aggregate masses to be effectively prevented.

The excessive aggregation of the silver particles proceeds particularly by drying, and therefore the surface treatment performed at any stage before the silver particles are dried is effective. For example, the surface treatment may be performed after the reduction step and before a later-mentioned washing step, performed simultaneously with the washing step, or performed after the washing step.

Among them, it is particularly preferable to perform the surface treatment after the reduction step and before the washing step or perform after the first washing step. That allows aggregates formed through the reduction treatment and having a predetermined size to be maintained, and silver particles including the aggregates undergo the surface treatment, and thus, a silver powder having good dispersibility can be produced.

More specifically, as mentioned above, with a water soluble polymer being added to a reducing agent solution at a predetermined ratio with respect to silver, reduction is performed, whereby the water soluble polymer moderately adsorbs onto the surfaces of the silver particles and aggregates formed of the silver particles connected to each other and having a predetermined size are formed. The water soluble polymer that adsorbs onto the silver particle surfaces is relatively easily washed by a washing treatment, and therefore, in the case where the washing step is performed prior to the surface treatment, there is a risk that the water soluble polymer on the silver particle surfaces is washed and removed, whereby the silver particles start to excessively aggregate each other, and coarse aggregate masses larger than the formed aggregates are formed. Furthermore, the formation of such coarse aggregate masses causes difficulties in giving the surface treatment uniformly to the silver particle surfaces.

Hence, the surface treatment is performed after the reduction step and before the washing step or performed after the first washing step enables excessive aggregation of the silver particles due to the removal of the water soluble polymer to be prevented and also the surface treatment to be efficiently applied to the silver particles including the desirably formed aggregates, whereby the silver powder including no coarse aggregate and having good dispersibility can be produced.

It should be noted that the surface treatment subsequent to the reduction treatment and prior to the washing step is preferably performed after a slurry containing the silver particles is solid-liquid separated using a filter press or the like after the completion of the reduction step. When the surface treatment is thus performed after the solid-liquid separation, a surface active agent and a dispersing agent each serving as a surface treatment agent can be made to act directly on the silver particles including the aggregates formed in a predetermined size, and the surface treatment agent appropriately adsorbs onto the formed aggregates to more effectively prevent the formation of aggregate masses which excessively aggregate.

In this surface treatment step, it is more preferable that the surface treatment is performed using both a surface active agent and a dispersing agent to form a coating layer comprising the surface active agent and the dispersing agent on the surfaces of the silver particles. Such surface treatment using both a surface active agent and a dispersing agent allows a firm surface-treated layer to be formed on the silver particle surfaces by the interaction of the surface active agent with the dispersing agent, and therefore, has a high effect of preventing excessive aggregation, and is effective in maintaining desired aggregates.

As a specific method of a preferable surface treatment using a surface active agent and a dispersing agent, it is beneficial that the silver particles are fed into water to which the surface active agent and the dispersing agent are added, and agitated; or the silver particles are fed into water to which the surface active agent is added, and agitated, and then the dispersing agent is added thereinto and agitated.

In the case where the surface treatment is performed simultaneously with the washing step, it is beneficial to add a surface active agent and a dispersing agent simultaneously to a washing liquid, or to add a dispersing agent after the addition of a surface active agent. In order to achieve better adsorption of a surface active agent and a dispersing agent onto the silver particles, it is preferable that the silver particles are fed into water or a washing liquid to each of which a surface active agent is added, and agitated, and then a dispersing agent is added thereinto and agitated.

Another embodiment may be such that a surface active agent is fed into a reducing agent solution, and a dispersing agent is fed into a silver particle slurry obtained by mixing a silver complex containing solution with the reducing agent solution, and agitated. A stable and uniform surface treatment can be performed in such a manner that a surface active agent is present at the stage of nucleation or nucleus growth to quickly adsorb onto formed nuclei or the surfaces of silver particles and furthermore a dispersing agent is made to adsorb thereonto.

Here, the surface active agent is not particularly limited, but a cationic surface active agent is preferably employed. A cationic surface active agent is ionized to form a positive ion without being affected by pH, and therefore, for example, there is obtained an effect of improving adsorption onto a silver powder obtained by using silver chloride as a starting material.

The cationic surface active agent is not particularly limited, but preferably at least one kind selected from alkyl monoamine salts, typified by monoalkylamine salts; alkyl diamine salts, typified by N-alkyl (C14 to C18) propylenediamine dioleate; alkyl trimethyl ammonium salts, typified by alkyl trimethyl ammonium chloride; alkyl dimethyl benzyl ammonium salts, typified by alkyl dimethyl benzyl ammonium chloride; quaternary ammonium salts, typified by alkyl dipolyoxyethylene methyl ammonium chloride; alkyl pyridinium salts; tertiary amine salts, typified by dimethylstearylamine; polyoxyethylene alkylamine, typified by polyoxypropylene polyoxyethylene alkylamine; diamine oxyethylene adducts, typified by N,N′,N′-tris(2-hydroxyethyl)-N-alkyl (C14 to C18) 1,3-diaminopropane, and more preferably any of or a mixture of a quaternary ammonium salt and a tertiary amine salt.

Furthermore, the surface active agent preferably has at least one alkyl group with a carbon number of C4 to C36, typified by a methyl group, a butyl group, a cetyl group, a stearyl group, beef tallow, hardened beef tallow, and a plant-based stearyl. As the alkyl group, preferable is an alkyl group to which at least one kind selected from polyoxyethylene, polyoxypropylene, polyoxyethylene polyoxypropylene, polyacrylic acid, and polycarboxylic acid is added. These alkyl groups can strongly adsorb to fatty acid which is to be used as a later-mentioned dispersing agent, and therefore, in the case where a dispersing agent is made to adsorb to silver particles via a surface active agent, fatty acid can be made to strongly adsorb thereto.

Furthermore, the amount of a surface active agent added is preferably in a range of 0.002% to 1.000% by mass with respect to the silver particles. Almost all amount of the surface active agent adsorbs onto the silver particles, and therefore, the addition amount of the surface active agent is almost equal to the adsorption amount thereof. When the amount of a surface active agent added is less than 0.002% by mass, an effect of preventing the aggregation of silver particles or an effect of improving adsorptivity of a dispersing agent sometimes cannot be obtained. On the other hand, when the amount of a surface active agent added is more than 1.000% by mass, the electrical conductivity of a wiring layer and an electrode which are formed using the silver paste is decreased, which is not preferable.

As the dispersing agent, for example, a protective colloid, such as fatty acid, organic metal, or gelatin, may be used, but, fatty acid or a salt thereof is preferably used because fatty acid and a salt thereof incur no risk of impurity contamination and have good adsorptivity to a surface active agent. It should be noted that fatty acid or a salt thereof may be added as an emulsion.

Fatty acid to be used as a dispersing agent is not particularly limited, but preferably at least one kind selected from stearic acid, oleic acid, myristic acid, palmitic acid, linoleic acid, lauric acid, and linolenic acid. This is because these kinds of fatty acid have a comparatively low boiling point and thus have less adverse effects on a wiring layer and an electrode which are formed using the silver paste.

The amount of a dispersing agent added is preferably in a range of 0.01 to 1.00% by mass with respect to the silver particles. The amount of a dispersing agent adsorbing onto the silver particles differs depending on the type of the dispersing agent, but, when the amount of a dispersing agent added is less than 0.01% by mass, a silver powder is not sometimes adsorbed by the dispersing agent in an amount large enough to achieve an effect of preventing aggregation of the silver particles or an effect of improving the adsorptivity of the dispersing agent. On the other hand, when the amount of a dispersing agent added is more than 1.00% by mass, too large an amount of the dispersing agent adsorbs the silver particles, and therefore a wiring layer and an electrode which are formed using the silver paste sometimes have insufficient electrical conductivity.

Next, the silver particles are washed. Onto the surfaces of the silver particles obtained by the reduction step, a large number of chlorine ions and the water soluble polymer adsorb. Therefore, in order to achieve sufficient electrical conductivity of a wiring layer and an electrode each formed using the silver paste, it is preferable to wash a slurry of the obtained silver particles in a subsequent washing step and remove the surface adsorbates. It should be noted that, as mentioned above, in order to prevent the occurrence of excessive aggregation due to the removal of the water soluble polymer adsorbing onto the silver particle surfaces, the washing step is preferably performed after the surface treatment step and the like for the silver particles.

A method for the washing is not particularly limited, but, there is commonly used a method in which silver particles separated from the silver particle slurry by solid-liquid separation using a filter press or the like are fed into a washing liquid and agitated using an agitator or an ultrasonic washer, and then solid-liquid separation is performed again to collect silver particles. Furthermore, in order to sufficiently remove surface adsorbates, there is preferably repeated several times an operation comprising feeding into a washing liquid, agitating and washing, and solid-liquid separation.

As the washing liquid, water may be used, or, in order to efficiently remove chlorine, an alkaline solution may be used. The alkaline solution is not particularly limited, but, a sodium hydroxide solution, which leaves less impurities and is inexpensive, is preferably used as an alkaline solution. In the case where a sodium hydroxide solution is used as a washing liquid, after the washing by the sodium hydroxide solution, the silver particles or a slurry thereof is preferably further washed to remove sodium.

The sodium hydroxide solution preferably has a concentration of 0.01 to 0.30 mol/l. An sodium hydroxide solution having a concentration of less than 0.01 mol/l has an insufficient washing effect, on the other hand, an sodium hydroxide solution having a concentration of more than 0.30 mol/l causes sodium in an amount more than allowed to remain in the silver particles. As the water used as a washing liquid, water containing no impurity element harmful to the silver particles is preferable, and pure water is particularly preferable.

After the washing, solid-liquid separation is performed to collect silver particles. As an apparatus to be used for the washing and the surface treatment of the silver particles, a commonly used apparatus, for example, a reaction vessel with an agitator, or the like may be used. Also, as an apparatus to be used for the solid-liquid separation, a commonly used apparatus, for example, a centrifuge, a suction filter, a filter press, or the like may be used.

The silver particles for which the washing and the surface treatment are completed are dried by evaporating moisture in a drying step. A method for the drying is such that, for example, a silver powder collected after completion of the washing and the surface treatment is placed on a stainless steel pad, and heated at a temperature of 40° C. to 80° C. using a commercially available drying apparatus, such as an air oven or a vacuum dryer.

Then, in the method for producing a silver powder in the present embodiment, under light pulverization conditions, a pulverization treatment is applied to a silver powder obtained after the drying, the silver powder being obtained by controlling the aggregation of silver particles by the reduction step and preferably stabilizing the degree of the aggregation by the surface treatment. In the silver powder after the foregoing surface treatment, even if the aggregates further aggregate each other due to the drying or the like after the surface treatment, the aggregates have a weak bonding strength, and therefore, at the time of producing a paste, the aggregates are easily separated from each other to the extent that the aggregates have a predetermined size. In order to stabilize the paste, pulverization and classification are preferably performed.

Specifically, the pulverization conditions of a pulverization method are such that, using a rolling agitator having a vacuum pressure-reduced atmosphere or the like which has a low pulverizing power, silver particles after the drying are pulverized while being agitated at a peripheral speed of an agitating impeller of, for example, 5 to 35 m/s. Such light pulverization of the silver powder obtained after the drying can prevent the aggregates formed of the silver particles connected to each other and having a predetermined size from being pulverized. When the peripheral speed is not more than 5 m/s, pulverization energy is weak, thereby making too large a number of aggregates remain, on the other hand, when the peripheral speed is more than 35 m/s, pulverization energy is strong, thereby making too small a number of aggregates remain, and thus, in both case, a silver powder having the foregoing particle size distribution cannot be obtained.

After the foregoing pulverization, classification is performed, whereby a silver powder having a desired particle size or less can be obtained. The classification apparatus to be used in the classification is not particularly limited, and an airflow classifier, a sieve, or the like may be used.

In the foregoing method for producing a silver powder, the addition of a predetermined amount of a water soluble polymer to a reducing agent solution or a silver complex containing solution enables the formation of aggregates in which silver particles are connected to each so as to achieve a ratio D₅₀/D_{SEM} of not less than 1.8 and not more than 4.2, and furthermore, the application of a surface treatment to the silver particles enables aggregation by the washing and the drying to be prevented, whereby the size of the aggregates can be maintained. The thus-obtained silver powder contains not coarse aggregates but aggregates having a size enough to achieve dispersibility, and includes silver particles having a structure by which the dispersibility of each of the primary particles is never higher than a fixed value. Therefore, the obtained silver powder has a maximum torque per specific surface area of not less than 2 N·g/m and not more than 5 N·g/m, thereby achieving both moderate thixotropy and dispersibility. A paste containing this silver powder is excellent in printability, causes no defect in plate releasing, and enables formation of an electrically conductive film excellent in electrical conductivity.

### EXAMPLE

Hereinafter, a specific example of the present invention will be described. It should be noted that the present invention is not limited to the following example.

### Example 1

In Example 1, while being agitated, 2490 g of silver chloride (manufactured by Sumitomo Metal Mining Co., Ltd., having a purity of not less than 99.9%, and containing 1875 g of silver in the silver chloride) was fed into 36 L of 25% aqueous ammonia maintained at a liquid temperature of 36° C. in a warm bath having a temperature of 38° C., whereby a silver complex solution was prepared. The obtained silver complex solution was maintained at a temperature of 36° C. in a warm bath.

On the other hand, 1317 g of ascorbic acid (a reagent, manufactured by KANTO CHEMICAL Co., Inc.) as a reducing agent was dissolved in 13.56 L of pure water having a temperature of 36° C., whereby a reducing agent solution was prepared. Next, a 94 g aliquot of polyvinyl alcohol (PVA205, manufactured by KURARAY Co., Ltd., 5% by mass with respect to the amount of silver in the silver complex solution) was taken as a water soluble polymer and dissolved in 1 L of pure water having a temperature of 36° C., and a thus-obtained solution was mixed with the reducing agent solution.

Using a Mono pump (manufactured by HEISHIN Ltd.), the prepared silver complex solution and the prepared reducing agent solution were sent to a pipe at 2.7 L/min and 0.9 L/min, respectively, whereby a silver complex was reduced. The reduction rate at this time was set to 127 g/min on the basis of the amount of silver. Furthermore, the ratio of the supply rate of a reducing agent to the supply rate of silver was set to 1.4. It should be noted that a polyvinyl chloride pipe having an inside diameter of 25 mm and a length of 725 mm was employed as a pipe. While being agitated, a slurry which contains silver particles obtained by the reduction of the silver complex was received in a receiving tank.

After that, the silver particle slurry obtained by the reduction was solid-liquid separated to collect silver particles, and then, the collected silver particles before drying, 1.9 g of polyoxyethylene addition quaternary ammonium salt (Cirrasol, manufactured by Croda Japan KK, 0.1% by mass with respect to the silver particles) as a surface treatment agent which is a commercial cationic surface active agent, and 37.5 g of a stearate emulsion comprising fatty acid, namely, stearic acid and palmitic acid, and a surface active agent (Selosol 920, manufactured by Chukyo Yushi Co., Ltd., 0.28% by mass of the stearic acid and the palmitic acid in total with respect to the silver particles) as a dispersing agent were fed into 15.4 L of pure water, and agitated for 60 minutes to perform a surface treatment. After the surface treatment, the silver particle slurry was filtered using a filter press, whereby the silver particles were solid-liquid separated.

Subsequently, before the collected silver particles were dried, the silver particles were fed into 15.4 L of a 0.05 mol/L sodium hydroxide solution, and agitated for 15 minutes and washed, and then filtered using a filter press to collect silver particles.

Next, the silver particles collected by solid-liquid separation were fed into 23 L of pure water, agitated, and filtered, and then, the silver particles were transferred to a stainless steel pad and dried at a temperature of 60° C. for 10 hours using a vacuum dryer. Then, a 1.75 kg aliquot of the silver powder was fed into a 5L high-speed agitator (a rolling agitator) (FMSC, manufactured by NIPPON COKE & ENGINEERING Co., Ltd.), and pulverized while being agitated for 30 minutes at a peripheral speed of 23 m/s, whereby a silver powder was obtained.

According to JIS K6217-4 (2008), using an absorption meter S-500 manufactured by Asahisouken Co., Ltd, there was determined the maximum torque of the obtained silver powder, the value obtained when a dibutyl phthalate ester was dropped into 200 g of the silver powder. Furthermore, separately, the specific surface area of the silver powder was determined based on the BET method, and the maximum torque per unit specific surface area was calculated. The following Table 1 provides the calculated value. As shown in Table 1, the maximum torque per unit specific surface area was 3.5 N·g/m.

Furthermore, the particle size distribution of the obtained silver powder was measured using a laser diffraction scattering type particle size distribution meter (Microtrac HRA 9320X-100, manufactured by Nikkiso Co., Ltd.). It should be noted that isopropyl alcohol was used as a dispersion medium and the silver powder was fed in and measured while being circulated inside the apparatus. The particle diameter (D₅₀) of the particle size distribution on a volume basis measured by laser diffraction scattering was 1.8 μm.

Furthermore, there was calculated a ratio D₅₀/D_{SEM} of the obtained silver powder, the ratio D₅₀/D_{SEM} being a ratio of a particle diameter D₅₀ of the silver powder on a volume basis measured by laser diffraction scattering to an average particle diameter D_{SEM} of the silver powder obtained by analyzing an image of the silver powder observed by a scanning electron microscope. It should be noted that the average particle diameter D_{SEM} was the average of values which were obtained by measuring not less than 300 silver particles using an image analysis software, Smile View (manufactured by JEOL Ltd.). The average particle diameter D_{SEM} that was obtained by analyzing the image of the silver powder observed by a scanning electron microscope was 0.75 μm, and the ratio D₅₀/D_{SEM} was 2.4.

In a small stainless steel plate, 9.2 g of the obtained silver powder and 0.8 g of a vehicle having a weight ratio of an epoxy resin (JER828, manufactured by Mitsubishi Chemical Corporation) to terpineol of 1:7 were weighed, and mixed using a metal spatula, and then, kneaded at 2000 rpm (a centrifugal force of 420 G) for 5 minutes with a rotary and revolutionary kneading machine (ARE-250, manufactured by THINKY CORPORATION), whereby a uniform paste was prepared. The obtained silver paste was kept in an ordinary room for one month, and as a result, it was confirmed that sedimentation of the silver powder did not occur and the initial state was maintained.

Furthermore, using a screen printer (MODEL-2300, MINAMI Co., Ltd.), wiring was printed on an alumina substrate with the paste obtained as mentioned above, and then the alumina substrate on which the wiring was printed was heat-treated for 60 minutes at a temperature of 200° C. in the atmosphere. The volume resistivity of wiring which was printed with the paste and heat-treated was measured using a resistivity meter (Loresta GP, manufactured by Mitsubishi Chemical Analytech Co., Ltd.). As a result, it was found that the volume resistivity of the paste was 6.9 μΩ·cm and the paste had excellent electrical conductivity.

### Comparative Example 1

In Comparative Example 1, a silver powder was produced in the same manner as in Example 1, except that the amount of polyvinyl alcohol (PVA205, manufactured by KURARAY Co., Ltd.) as a water soluble polymer mixed with the reducing agent solution was 282 g (15% by mass with respect to the amount of silver in the silver complex solution).

The obtained silver powder was evaluated in the same manner as in Example 1. The following Table 1 shows each of the measured values. The maximum torque per unit specific surface area was 5.5 N·g/m, and the particle diameter (D₅₀) of the particle size distribution on a volume basis measured by laser diffraction scattering was 1.4 μm, and the average particle diameter (D_{SEM}) obtained by analyzing an image observed by a scanning electron microscope was 0.81 μm, and hence the ratio D₅₀/D_{SEM} was 1.7. Then, in the same manner as in Example 1, a silver paste was kept in an ordinary room for one month, and as a result, it was confirmed that sedimentation of the silver powder did not occur and the initial state was maintained.

Furthermore, as in the same manner as in Example 1, a silver paste obtained by kneading the obtained silver powder, terpineol, and the resin at 2000 rpm (a centrifugal force of 420 G) with a rotary and revolutionary kneading machine was printed on an alumina substrate, and, as a result, it was observed that bleeding occurred and spread between wirings and printability was deteriorated.

### Comparative Example 2

In Comparative Example 2, a silver powder was produced in the same manner as in Example 1, except that the amount of the polyvinyl alcohol (PVA205, manufactured by KURARAY Co., Ltd.) as a water soluble polymer mixed with the reducing agent solution was 38 g (2% by mass with respect to the amount of silver in the silver complex solution).

The obtained silver powder was evaluated in the same manner as in Example 1. The following Table 1 shows each of the measured values. The maximum torque per unit specific surface area was 1.9 N·g/m, and the particle diameter (D₅₀) of the particle size distribution on a volume basis measured by laser diffraction scattering was 3.1 μm, and the average particle diameter (D_{SEM}) obtained by analyzing an image observed by a scanning electron microscope was 0.72 μm, and hence the ratio D₅₀/D_{SEM} was 4.3. Then, in the same manner as in Example 1, a silver paste was kept in an ordinary room for one month, and as a result, it was confirmed that sedimentation of the silver powder occurred.

Furthermore, as in the same manner as in Example 1, a silver paste obtained by kneading the obtained silver powder, terpineol, and an resin at 2000 rpm (a centrifugal force of 420 G) by using a rotary and revolutionary kneading machine was printed on an alumina substrate, and, as a result, it was found that the volume resistivity of the paste was 19.1 μΩ·cm and hence the paste had inferior electrical conductivity as shown in Table 1.

TABLE 1

| | | Comparative | Comparative |
|---|---|---|---|
| | Example 1 | Example 1 | Example 2 |
| Maximum torque | 2.1 | 3.0 | 1.2 |
| (Nm) | | | |
| Specific surface area | 0.61 | 0.57 | 0.64 |
| (m²/g) | | | |
| Maximum torque per | 3.5 | 5.5 | 1.9 |
| unit specific surface | | | |
| area (N · g/m) | | | |
| D_{SEM} | 0.75 | 0.81 | 0.72 |
| (μm) | | | |
| D₅₀ | 1.8 | 1.4 | 3.1 |
| (μm) | | | |
| D₅₀/D_{SEM} | 2.4 | 1.7 | 4.3 |
| Volume resistivity | 6.9 | Unmeasurable due | 19.1 |
| (μΩ · cm) | | to printing defects | |

1. A silver powder, having a maximum torque per specific surface area of not less than 2 N·g/m and not more than 5 N·g/m, said maximum torque per specific surface area being obtained by dividing a maximum torque by a specific surface area determined by BET method, said maximum torque being determined in accordance with a method for measuring an absorption amount which is defined by Japanese Industrial Standard (JIS) K6217-4.

2. The silver powder according to claim 1, the silver powder having:
a number average particle diameter D_{SEM} of not less than 0.2 μm and not more than 2.0 μm, said number average particle diameter D_{SEM} being determined by an image observed by a scanning electron microscope; and
a ratio D₅₀/D_{SEM} of not less than 1.8 and not more than 4.2, said ratio D₅₀/D_{SEM} being a ratio of a particle diameter D₅₀ on a volume basis measured by laser diffraction scattering to the number average particle diameter D_{SEM}.

3. The silver powder according to claim 1, the silver powder having a volume resistivity of not more than 10 μΩ·cm when a silver paste obtained by kneading the silver powder, terpineol, and a resin with a rotary and revolutionary agitator at a centrifugal force of 420 G is printed on an alumina substrate and baked for 60 minutes at a temperature of 200° C. in the atmosphere.

4. The silver powder according to claim 2, the silver powder having a volume resistivity of not more than 10 μΩ·cm when a silver paste obtained by kneading the silver powder, terpineol, and a resin with a rotary and revolutionary agitator at a centrifugal force of 420 G is printed on an alumina substrate and baked for 60 minutes at a temperature of 200° C. in the atmosphere.

5. A silver paste, containing not less than 50% by mass of the silver powder according to claim 1.

6. A silver paste, containing not less than 50% by mass of the silver powder according to claim 2.

7. A silver paste, containing not less than 50% by mass of the silver powder according to claim 3.

8. A silver paste, containing not less than 50% by mass of the silver powder according to claim 4.
